(19) United States
(12) Patent Application Publication
(10) Pub. No.: US 2022/0040032 A1
(43) Pub. Date: Feb. 10, 2022

(54) HAND-HELD MASSAGE GUN AND CONVERSION MECHANISM THEREOF

(71) Applicant: New Era AI Robotic Inc., Taipei City (TW)

(72) Inventors: Ting-Shuo CHEN, Taipei City (TW); Po-Chun CHIA, Taipei City (TW)

(21) Appl. No.: 17/033,686

(22) Filed: Sep. 26, 2020

(30) Foreign Application Priority Data
Aug. 7, 2020 (CN) 202021636743.5

(51) Int. Cl. A61H 23/00; A61H 23/02; A61H 15/00

(52) U.S. Cl. CPC A61H 23/006; A61H 23/004; A61H 15/0085; A61H 23/0263

(57) ABSTRACT

A hand-held massage gun and conversion mechanism thereof are disclosed. The hand-held massage gun includes a massage gun body and a conversion mechanism. The massage gun body includes an output rod. The conversion mechanism includes a hollow shell, a movable block and return springs. The hollow shell is detachably connected to the massage gun body, and two ends of the hollow shell are provided with an opening and a long hole. The movable block is accommodated in the hollow shell. The movable block has an inclined surface, an abutting portion and a linkage rod inserted in the long hole. The output rod is inserted in the opening and abutted against the inclined surface. The return springs are elastically supported between the hollow shell and the abutting portion.

### BACKGROUND OF THE INVENTION

### Technical Field

The technical field relates to a massage machine, and more particularly, to a hand-held massage gun and conversion mechanism thereof.

### Description of Related Art

Regular exercise or poor posture can cause people to be prone to muscle fatigue and soreness. As a result, there exists a hand-held massage gun on the market which can lightly tap muscles or acupuncture points of the body to provide a massage and soothing effects on the muscles or acupuncture points.

However, the above hand-held massage guns are only able to provide a tapping function, which is obviously insufficient when compared to a professional massage. Therefore, the design of a hand-held massage gun with the functions of tapping and pushing is the development target of the industry.

In view of the above drawbacks, the inventor proposes the present invention based on his expert knowledge and elaborate research in order to solve the problems of prior art.

### SUMMARY OF THE INVENTION

The disclosure is directed to a hand-held massage gun and conversion mechanism thereof, in which the output rod of the massage gun body can provide a tapping function, and the linkage rod of the conversion mechanism can provide a pushing function for the hand-held massage gun to selectively switch between functions of tapping and pushing; thus, the hand-held massage gun has multiple massage modes and the efficacy of massage can be improved.

In one of the exemplary embodiments, a hand-held massage gun comprises a massage gun body and a conversion mechanism. The massage gun body includes a housing and a driving module accommodated in the housing. The housing has a through hole. The driving module includes an output rod inserted in the through hole which reciprocates along an axial direction of the through hole. The conversion mechanism includes a hollow shell, a movable block and at least one return spring. The hollow shell is detachably connected to the housing, and one end of the hollow shell has an opening and another end has a long hole. The movable block is accommodated in the hollow shell. One side of the movable block has an inclined surface disposed corresponding to the opening and another side has an abutting portion, and a further side is extended with a linkage rod inserted in the long hole. The output rod is inserted in the opening and abutted against the inclined surface. The at least one return spring is elastically supported between the hollow shell and the abutting portion, wherein when the output rod reciprocates along an axial direction of the through hole, and the output rod pushes the linkage rod to reciprocate along a radial direction of the long hole along the inclined surface.

In one of the exemplary embodiments, a conversion mechanism of hand-held massage gun comprises a hollow shell, a movable block and at least one return spring. One end of the hollow shell has an opening and another end has a long hole. The movable block is accommodated in the hollow shell. One side of the movable block has an inclined surface disposed corresponding to the opening and another side has an abutting portion, and a further side is extended with a linkage rod inserted in the long hole separately. The output rod is inserted in the opening and abutted against the inclined surface. The at least one return spring is elastically supported between the hollow shell and the abutting portion.

Based on the above, the output rod reciprocates telescopically relative to the massage gun body to provide a tapping function, and the linkage rod of the conversion mechanism reciprocates horizontally relative to the massage gun body to provide a pushing function. With the conversion mechanism that can be assembled or disassembled to the massage gun body, the hand-held massage gun can selectively switch between functions of tapping and pushing; therefore, the hand-held massage gun has multiple massage modes and the efficacy of massage can be improved.

Based on the above, the conversion mechanism of the disclosed example utilizes the movable block with three different sides to provide an inclined surface, to support return springs and to extend a linkage rod separately; the output rod abuts against the inclined surface as to achieve the effect that the movement of the output rod and the linkage rod are perpendicular to each other. Therefore, to compare with driving mechanisms such as conventional gears and linkages, the hand-held massage gun and conversion mechanism of the present disclosed example have the advantages of simpler structures, lighter volume and weight, lower operation noise and higher output efficiency.

### BRIEF DESCRIPTION OF DRAWINGS

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective assembly view of the hand-held massage gun of the present disclosed example.

FIG. 2 is a perspective explosion view of the hand-held massage gun of the present disclosed example.

FIG. 3 is a schematic view of a soft ball sleeve to be attached to the linkage rod of the present disclosed example.

FIG. 4 is an operation schematic view of the hand-held massage gun of the present disclosed example.

FIG. 5 is another operation schematic view of the hand-held massage gun of the present disclosed example.

FIG. 6 is a further operation schematic view of the hand-held massage gun of the present disclosed example.

FIG. 7 is a schematic view of a soft ball sleeve to be attached to the output rod of the present disclosed example.

FIG. 8 is still another operation schematic view of the hand-held massage gun of the present disclosed example.

### DETAILED DESCRIPTION OF THE PREFERRED EMBODIMENTS

In cooperation with attached drawings, the technical contents and detailed description of the invention are described thereinafter according to a number of preferable embodiments, and are not being used to limit its executing scope. Any equivalent variation or modification made according to appended claims is all covered by the claims claimed by the present invention.

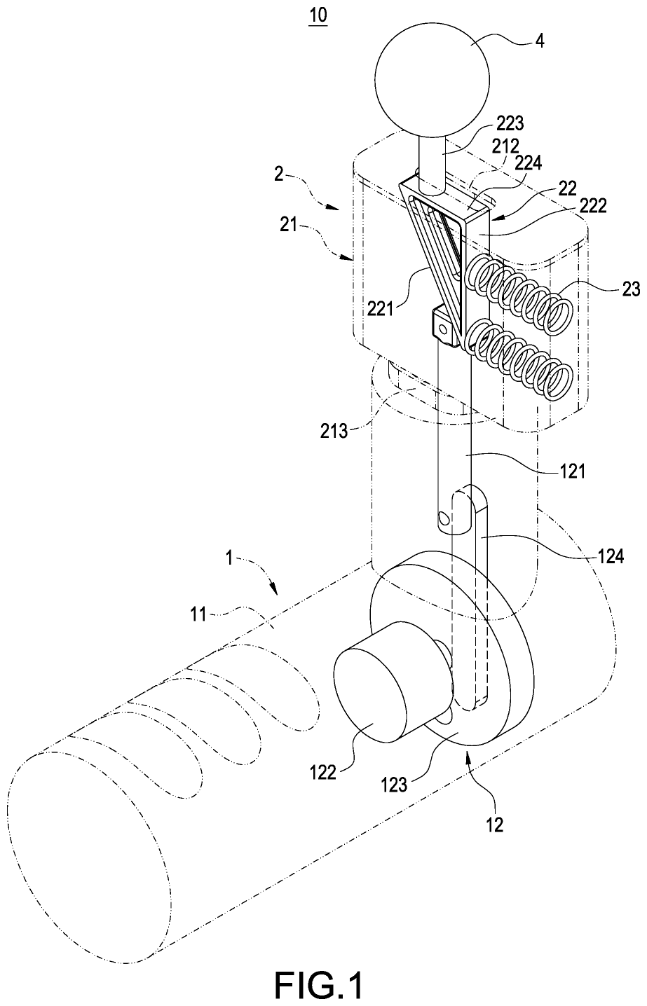

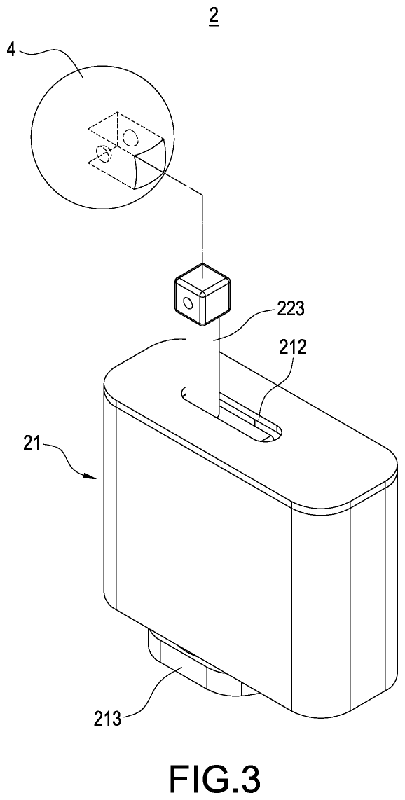

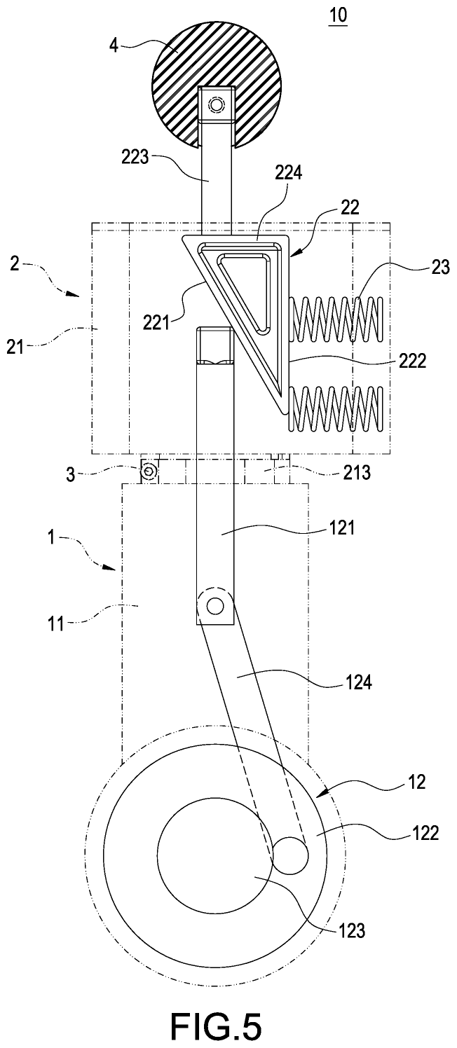

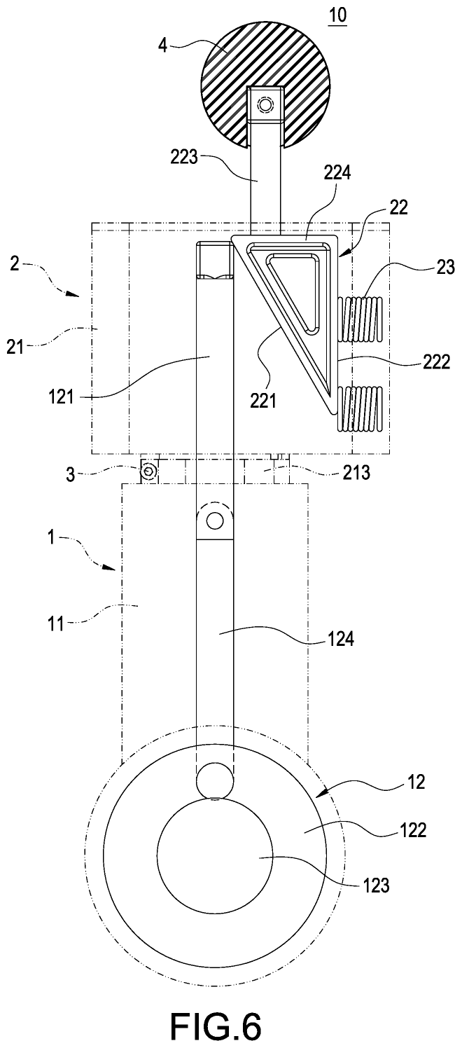

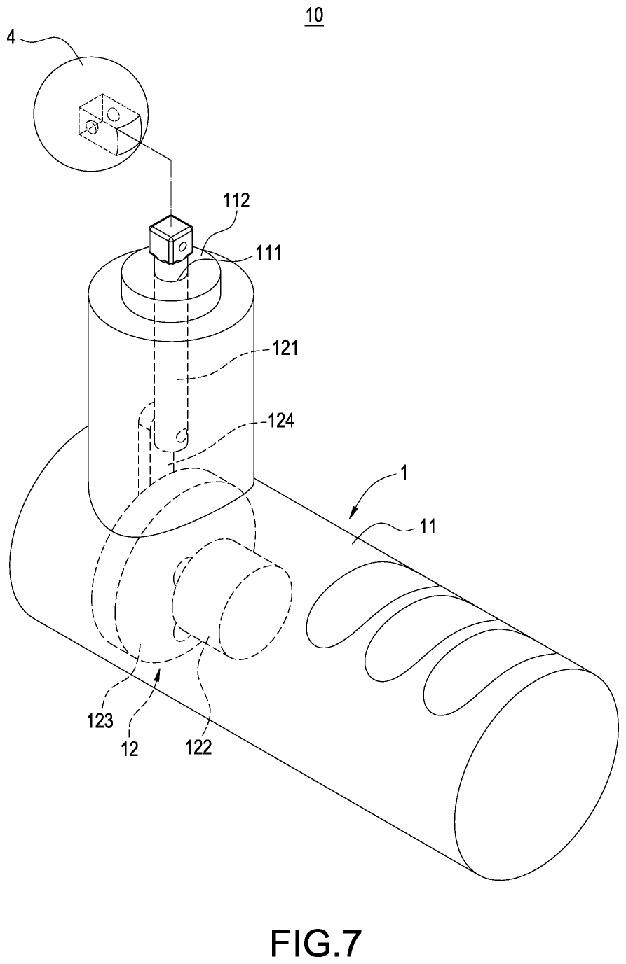

Please refer to FIG. 1 to FIG. 8. The present disclosed example provides a hand-held massage gun and conversion mechanism thereof. The hand-held massage gun 10 mainly includes a massage gun body 1 and a conversion mechanism 2. The conversion mechanism 2 mainly includes a hollow shell 21, a movable block 22 and one or a plurality of return spring 23.

As shown in FIG. 1 to FIG. 2 and FIG. 4 to FIG. 8. The massage gun body 1 includes a housing 11 and a driving module 12 accommodated in the housing 11. The housing 11 has a through hole 111. The driving module 12 includes an output rod 121 inserted in the through hole 111 which reciprocates along an axial direction of the through hole 111, wherein the housing 11 extends outwardly a bump 112, and the through hole 111 is formed from the bump 112.

More details are as follows. The driving module 12 further includes a driving motor 122, an eccentric wheel 123 and a follower rod 124. The eccentric wheel 123 is connected to the driving motor 122 and is driven by the driving motor 122 to rotate. One end of the follower rod 124 is fixed at the eccentric wheel 123 and another end is pivotally connected to the output rod 121; thus, when the eccentric wheel 123 rotates, it will also drive the driven rod 124 to rotate at one end fixed at the eccentric wheel 123, wherein an axial direction of the eccentric wheel 123 is disposed perpendicular to an axial direction of the through hole 111.

As shown in FIG. 1 to FIG. 6, the conversion mechanism 2 can be assembled or detachably connected to the housing 11. The conversion mechanism 2 mainly includes a hollow shell 21, a movable block 22 and return springs 23.

As shown in FIG. 1 to FIG. 6, the hollow shell 21 is detachably connected to the housing 11. One end of the hollow shell 21 has an opening 211 and another end has a long hole 212. The hollow shell 21 further extends a C-shaped collar 213 surrounding the opening 211. One end of the C-shaped collar 213 has a fixed end 214 connected to the hollow shell 21, and another end of the C-shaped collar 213 has a free end 215 separated from the hollow shell 21, wherein a radial direction of the long hole 212 is disposed perpendicular to an axial direction of the through hole 111.

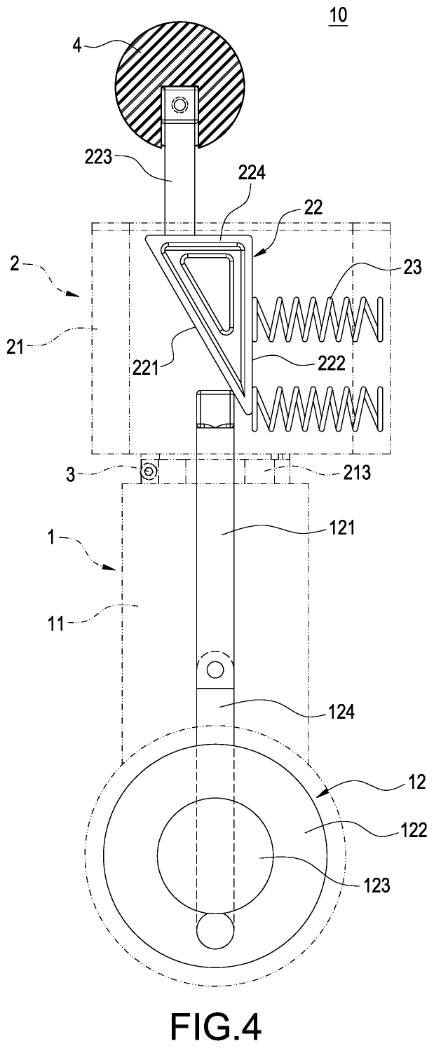

As shown in FIG. 1, FIG. 4 to FIG. 6, the movable block 22 is accommodated in the hollow shell 21. One side of the movable block 22 has an inclined surface 221 disposed corresponding to the opening 211 and another side has an abutting portion 222, and a further side has extended a linkage rod 223 inserted in the long hole 212, wherein one side of the movable block 22 has the thickness gradually decreased in a direction of approaching the output rod 121 to form an inclined surface 221 base on the butting portion 222.

Further explanation is as follows. The movable block 22 is a triangular block 224. The inclined surface 221 is formed on a hypotenuse of the triangular block 224, and the abutting portion 222 is formed on an opposite side of the triangular block 224, and the linkage rod 223 is extended from an adjacent side of the triangular block 224.

The shape of the movable block 22 of the present disclosed example is not limited to the triangular block 224, but the movable block 22 must have three different sides to form an inclined surface 221, an abutting portion 222 and a linkage rod 223 separately. Therefore, the shape of the movable block 22 can also be any geometric shape, such as a rhombus or a pentagon, with three or more sides, in which one of the sides is a hypotenuse.

Please refer to FIG. 1 and FIG. 4 to FIG. 6. The number of return springs 23 of the present embodiment is two, but is not limited thereto. Each return spring 23 is elastically supported between the hollow shell 21 and the abutting portion 222. Each return spring 23 is used to push the movable block 22 to reset in the direction away from the hollow shell 21.

When the conversion mechanism 2 is assembled to the housing 11, the output rod 121 is inserted the opening 211 and abutted against the inclined surface 221. Moreover, when the output rod 121 reciprocates along the axial direction of the through hole 111, the output rod 121 can push the linkage rod 223 to reciprocate along the radial direction of the long hole 212 through the inclined surface 221.

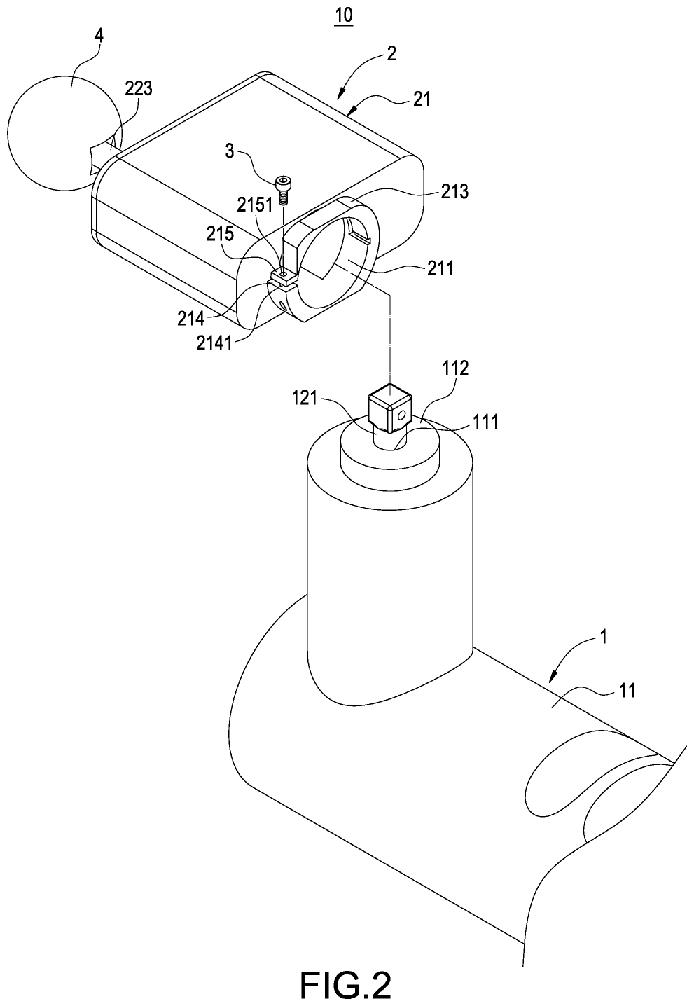

As shown in FIG. 2 and FIG. 4 to FIG. 6, the hand-held massage gun 10 of the present disclosed example further includes a fastening piece 3. The fixed end 214 has a first fastening hole 2141, and the free end 215 has a second fastening hole 2151. First, the bump 112 is inserted in the C-shaped collar 213, then the fastening piece 3 is fastened in the first fastening hole 2141 and the second fastening hole 2151 so that the free end 215 moves closer to the fixed end 214 to tighten the bump 112; therefore, the C-shaped collar 213 is tightly sleeved on the bump 112, wherein the fastening piece 3 of the present disclosed example is, but not limited to, a screw.

In addition, the assembly or disassembly of the conversion mechanism 2 to the housing 11 of the massage gun body 1 can be achieved by fastening or loosening the fastening piece 3 in the first fastening hole 2141 and the second fastening hole 2151.

As shown in FIG. 1 to FIG. 8, the hand-held massage gun 10 of the present disclosed example further includes a soft ball sleeve 4. The soft ball sleeve 4 is made of soft materials such as sponge, silicone or rubber etc. The soft ball sleeve 4 can optionally be sleeved on the end of the output rod 121 or the linkage rod 223 to enhance the comfort of the hand-held massage gun 10 during a massage.

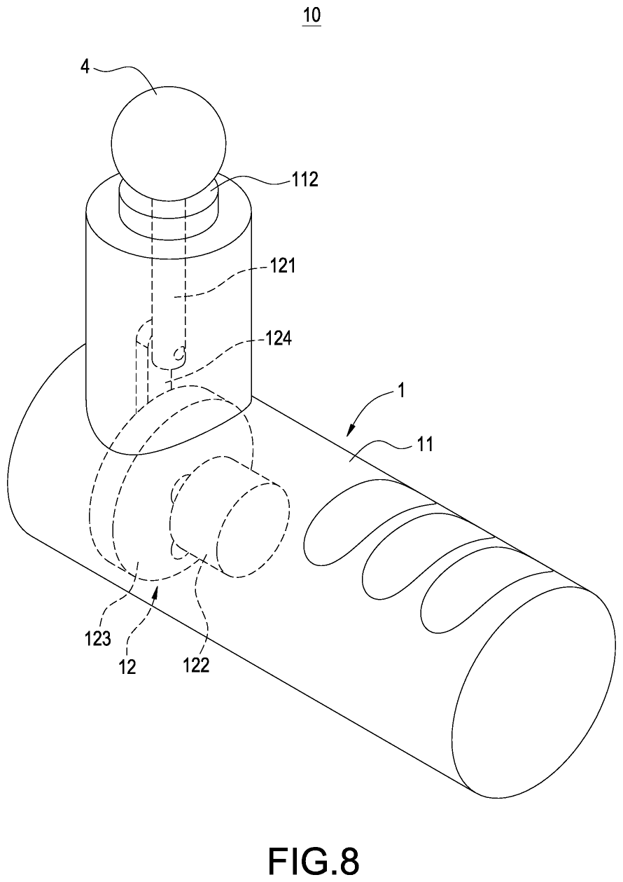

FIG. 4 to FIG. 6 and FIG. 8 depict operation schematic views of the hand-held massage gun 10 and the conversion mechanism 2. First, as shown in FIG. 8, when the massage gun body 1 is activated, the driving motor 122 will drive the eccentric wheel 123 and the follower rod 124 to rotate. The follower rod 124 then drives the output rod 121 to reciprocate along the axial direction of the through hole 111 so that the output rod 121 can provide a tapping function when contacting muscles or acupuncture points.

Moreover, as shown in FIG. 4 to FIG. 6, when the user does not need the tapping function, the conversion mechanism 2 is assembled to the housing 11 of the massage gun body 1, and the output rod 121 is inserted in the opening 211 and abutted against the inclined surface 221. Thus, during the reciprocating movement of the output rod 121 along the axial direction of the through hole 111, the output rod 121 can push the movable block 22 through the inclined surface 221 so that the movable block 22 compresses the return springs 23; or the output rod 121 can be far away from the movable block 22 so that the return springs 23 push the movable block 22 to reset in the direction away from the hollow shell 21. Hence, the linkage rod 223 is driven to reciprocate along the radial direction of the long hole 212 so that the linkage rod 223 can provide a pushing function when it contacts muscles or acupuncture points.

Thereby, the output rod 121 reciprocates telescopically relative to the massage gun body 1 to provide a tapping function, and the linkage rod 223 of the conversion mechanism 2 reciprocates horizontally relative to the massage gun body 1 to provide a pushing function. As the conversion mechanism 2 can be assembled or disassembled to the massage gun body 1, the hand-held massage gun 10 can selectively switch between functions of tapping and pushing so that the hand-held massage gun 10 has multiple massage modes to improve the efficacy of the massage.

Moreover, the conversion mechanism 2 of the present disclosed example utilizes the movable block 22 with three different sides to provide an inclined surface 221, to support return springs 23 and to extend a linkage rod 223 separately; the output rod 121 abuts against the inclined surface 221 so that the movement of the output rod 121 and the linkage rod 223 are perpendicular to each other. Therefore, to compare with driving mechanisms such as conventional gears and linkages, the hand-held massage gun 10 and conversion mechanism 2 of the present disclosed example have advantages of simpler structures, lighter volume and weight, lower operation noise and higher output efficiency.

In summary, the hand-held massage gun and conversion mechanism thereof of the present disclosed example can indeed achieve the intended purposes of use and solve the lack of conventional knowledge to fully meet the requirements of a patent to file the application in accordance with the Patent Law. Please research and grant the present disclosed example to protect the rights of the inventor.

Although the present disclosed example has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A hand-held massage gun, comprising:
a massage gun body including a housing and a driving module accommodated in the housing; the housing having a through hole; and the driving module including an output rod inserted in the through hole and reciprocating along an axial direction of the through hole; and
a conversion mechanism, including:
a hollow shell detachably connected to the housing, and one end of the hollow shell having an opening and another end having a long hole;
a movable block accommodated in the hollow shell, and one side of the movable block having an inclined surface disposed corresponding to the opening and another side having an abutting portion, and a further side extending a linkage rod inserted in the long hole; and the output rod being inserted in the opening and abutted against the inclined surface; and
at least one return spring elastically supported between the hollow shell and the abutting portion;
wherein, when the output rod reciprocates along an axial direction of the through hole, and the output rod pushes the linkage rod to reciprocate along a radial direction of the long hole through the inclined surface.

2. The hand-held massage gun according to claim 1, wherein the movable block is a triangular block; the inclined surface is formed on a hypotenuse of the triangular block; the abutting portion is formed on an opposite side of the triangular block; and the linkage rod is extended from an adjacent side of the triangular block.

3. The hand-held massage gun according to claim 1, wherein the housing extends outwardly a bump, and the through hole is formed from the bump.

4. The hand-held massage gun according to claim 3, wherein the hollow shell extends a C-shaped collar surrounding the opening, and one end of the C-shaped collar has a fixed end connected to the hollow shell and another end has a free end separated from the hollow shell.

5. The hand-held massage gun according to claim 4, further including a fastening piece, wherein the fixed end has a first fastening hole, and the free end has a second fastening hole; the bump is inserted in the C-shaped collar; and the fastening piece is fixed in the first fastening hole and the second fastening hole so that the free end moves closer to the fixed end to tighten the bump.

6. The hand-held massage gun according to claim 1, wherein the driving module further includes a driving motor, an eccentric wheel connected to the driving motor and driven by the drive motor to rotate and a follower rod having one end fixed at the eccentric wheel and another end pivotally connected to the output rod; and an axial direction of the eccentric wheel is disposed perpendicular to an axial direction of the through hole.

7. A conversion mechanism of hand-held massage gun, comprising:
a hollow shell, one end having an opening and another end having a long hole;
a movable block accommodated in the hollow shell, one side of the movable block having an inclined surface disposed corresponding to the opening and another side having an abutting portion, and a further side extending a linkage rod inserted in the long hole;
at least one return spring, elastically supported between the hollow shell and the abutting portion.

8. The conversion mechanism of hand-held massage gun according to claim 7, wherein the movable block is a triangular block; the inclined surface is formed on a hypotenuse of the triangular block; the abutting portion is formed on an opposite side of the triangular block; and
the linkage rod is extended from an adjacent side of the triangular block.

9. The conversion mechanism of hand-held massage gun according to claim 7, wherein the hollow shell extends a C-shaped collar surrounding the opening, and one end of the C-shaped collar has a fixed end connected to the hollow shell and another end has a free end separated from the hollow shell.

10. The conversion mechanism of hand-held massage gun according to claim 9, further including a fastening piece, wherein the fixed end has a first fastening hole, and the free end has a second fastening hole; and the fastening piece is fixed in the first fastening hole and the second fastening hole.
